(19) United States
(12) Patent Application Publication
(10) Pub. No.: US 2024/0132233 A1
(43) Pub. Date: Apr. 25, 2024

(54) LAUNCH VEHICLE DISPENSER ATTACH STRUCTURE AND METHOD

(71) Applicant: REPRISE SPACE SOLUTIONS, LLC, Houston, TX (US)

(72) Inventors: Michael David Johnson, Houston, TX (US); Victor James Dube, Houston, TX (US); Tyler Gerald Holden, Houston, TX (US)

(21) Appl. No.: 18/542,105

(22) Filed: Dec. 15, 2023

Related U.S. Application Data
(63) Continuation of application No. 17/493,563, filed on Oct. 4, 2021, now abandoned.
(60) Provisional application No. 63/087,255, filed on Oct. 4, 2020.

(51) Int. Cl. B64G 1/64; B64G 1/00

(52) U.S. Cl. CPC B64G 1/641; B64G 1/002; B64G 1/645; B64G 1/643

(57) ABSTRACT

A launch vehicle dispenser attach structure is disclosed. The launch vehicle dispenser attach structure includes a launch vehicle adapter, and a polygonal extruded cylinder comprising tapered side and an essentially closed end. The polygonal extruded cylinder connects to the launch vehicle adapter. The tapered sides and the closed end of the polygonal extruded cylinder provide mounting interfaces for connecting satellite dispensers. A mounting interface of the mounting interfaces includes a separation ring for transforming the launch vehicle dispenser attach structure into a free flying satellite. The launch vehicle dispenser attach structure is particularly useful for attaching multiple payload separation systems to launch vehicle.

### CROSS-REFERENCE TO RELATED APPLICATIONS

The present application is a continuation of U.S. Non-Provisional application Ser. No. 17/493,563, filed on Oct. 4, 2021; which claims the benefit of U.S. Provisional Patent Application No. 63/087,255, filed on Oct. 4, 2020; all of which are incorporated herein in their entirety and referenced thereto.

### FIELD OF INVENTION

This disclosure relates generally to a launch vehicle dispenser attach structure and method utilizing a tapered prismatic cylindrical structural means for connecting satellite dispensers to a launch vehicle that maximizes strength to weight ratio.

### BACKGROUND

Traditional utilization of launch vehicle volume under a launch vehicle fairing requires maximization of volume utilization. This includes adding what are termed “Rideshare” or secondary payloads in any available volumes. Launch vehicles often employ a cylindrical payload attach ring oriented with the cylindrical axis of the attach ring parallel with the rocket axis to attach multiple satellites to multiple launch vehicle attach rings with their respective cylindrical axes oriented orthogonally to the main cylinder and located around the periphery of the cylinder to enable a shared launch for multiple satellites. An example of such an attach ring is called the EELV Secondary Payload Adapter—ESPA, also called an ESPA ring. Such devices maximize the utilization of volume under the fairing of a launch vehicle at the expense of less than optimal orientations of the satellites for launch. For example, the main launch loads for these satellites are side loads to the main axis of the spacecraft—the worst possible loading in contrast to traditional on-axis loading of standard satellite placement on a rocket. This imposes severe structural constraints on any structure mounted to such interfaces. ESPA rings are also known to have wedge shaped satellite accommodation volumes rather than cylindrical or rectangular satellite accommodation volumes.

To maximize satellite volume utilization, satellite designers tend to design rectangular shaped satellites. Rectangular satellites then require rectangular attach structures that interface to a launch vehicle. Unfortunately, launch vehicle attach structures are generally tubular in nature (e.g. ESPA Ring interfaces). The problem then devolves into interfacing a flat plate to a tubular or circular interface. A flat plate to cylinder design generally has a low strength to weight ratio. In other words, the structure becomes very heavy to support its design load without yielding.

Tubular structures (other than spheres) have some of the highest strength to weight ratios. Cone shaped structures can also increase the strength to weight ratio of an equivalent cylinder structure. Strength can be further increased by adding bends or corners in a structure.

As such, it is desirable to combine these stated advantages to maximize volume utilization and mass carrying capability at each launch vehicle interface.

The disclosed subject matter helps to solve these and other problems.

### SUMMARY

The present invention relates generally to a launch vehicle dispenser attach structure and method utilizing a tapered prismatic cylindrical structural means for connecting satellite dispensers to a launch vehicle that maximizes strength to weight ratio.

The inventive device/structure utilizes a cone shaped launch vehicle interface adapter that joins with a polygonal (e.g. three or greater sided) extruded cylinder with tapered sides and an essentially closed end. Each flat side of the adapter provides a convenient interface to a rectangular or cylindrical satellite dispenser interface.

The inventive structures are fundamentally tubular in nature and have high strength to weight ratios. Since the sides are tapered, this emulated cone shape also increases the strength above an equivalent cylinder structure. Strength is further increased by adding bends that form the polygonal structure and corners that form when the end of the cylinder opposite of the launch vehicle interface is closed out with a cap.

The structure can be formed of any convenient material or combination of materials, preferably a high strength to weight ratio metal (e.g. 6061 aluminum alloy) or some form of composite structure (e.g. carbon fiber/epoxy matrix) or a honeycomb core and metal or composite material combination.

When an attach structure is formed utilizing these attributes, an extremely high strength to weight ratio is achieved as well as a relatively high resonant frequency. This is desirable in a launch vehicle/satellite combination to eliminate resonance of the satellite due to launch vehicle induced vibrations that would lead to structural failure during launch.

The main advantage of using the invention is the provision of a novel means of forming a launch vehicle attach structure that permits full mass utilization of each launch vehicle interface while also efficiently utilizing the satellite accommodation volume associated with the respective launch vehicle interface.

Some applications of the structural system include adapting multiple CubeSat dispensers to a launch vehicle, adapting multiple satellite dispensers to a launch vehicle, and forming the main structure of an upper stag amongst other things.

### BRIEF DESCRIPTION OF THE DRAWINGS

A more complete understanding of the invention and the many attendant advantages thereof will be readily appreciated as the same becomes better understood by reference to the following detailed description, when considered in connection with the accompanying drawings wherein:

FIG. 1A is an orthogonal view of the first embodiment with CubeSat dispensers.

FIG. 1B is a side view of the first embodiment with CubeSat dispensers.

FIG. 2 is a cutaway view of the first embodiment with CubeSat dispensers.

FIG. 3 is an orthogonal view of a second embodiment with CubeSat dispensers and satellite dispensers.

FIG. 4 is an orthogonal view of a third embodiment that forms a free flying satellite with CubeSat dispensers and satellite dispensers.

### DESCRIPTION OF THE PREFERRED EMBODIMENT

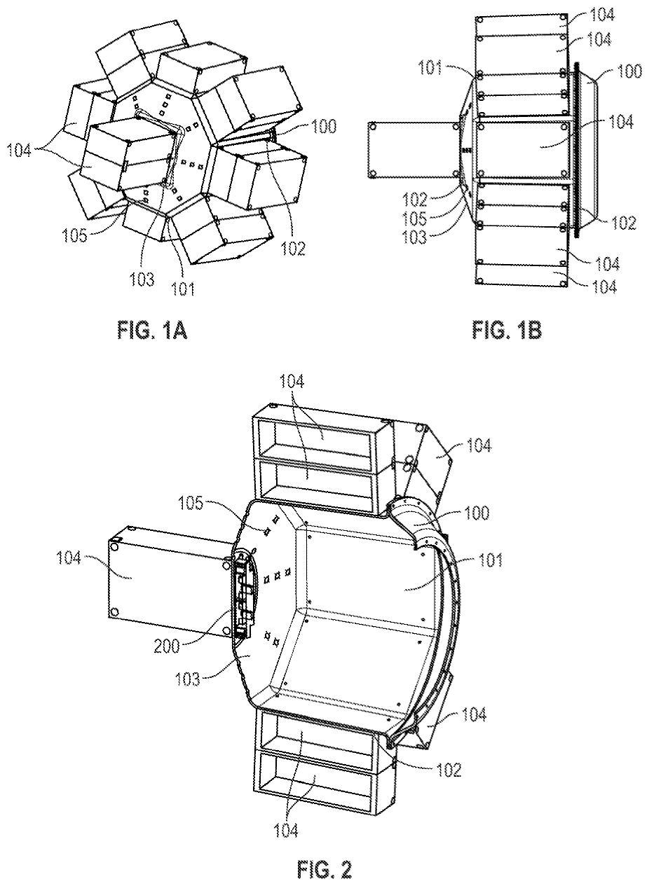

In FIG. 1A, the inventive device is illustrated using a cone shaped launch vehicle interface adapter 100 (or launch vehicle adapter 100) that is attached (via bolts) to a launch vehicle (not shown) and joins (via bolts, bonded, welded, etc.) with a polygonal (in this example eight sided) extruded cylinder 101 with tapered sides 102 and an essentially closed end 103. Each flat side 102 of the adapter 101 provides a convenient interface to a rectangular or cylindrical satellite dispenser 104. Satellite dispenser 104 is bolted to structure 101. Holes 105 provide cable pass throughs in structure 101 to provide control and power cable connectivity to each of satellite dispensers 104.

FIG. 1B is a side view of the inventive device shown in FIG. 1a. Note the draft angle of tapered sides 102 which add to the overall strength and stiffness of structure 101.

FIG. 2 is a cutaway view of the inventive device illustrating the hollow area in the center of structure 101. Electronic controller 200 is connected to the backside of closed end 103 and communicates to dispensers 104 via cables (not shown) to provide deployment command signals and power to dispensers 104. Electronic controller 200 also communicates with the launch vehicle via cables that pass through the open hole in launch vehicle adapter 100. Angles formed in structure 101 are clearly seen on the backside of tapered sides 102 and between tapered sides 102 and closed end 103 which increase the overall strength and stiffness of structure 101.

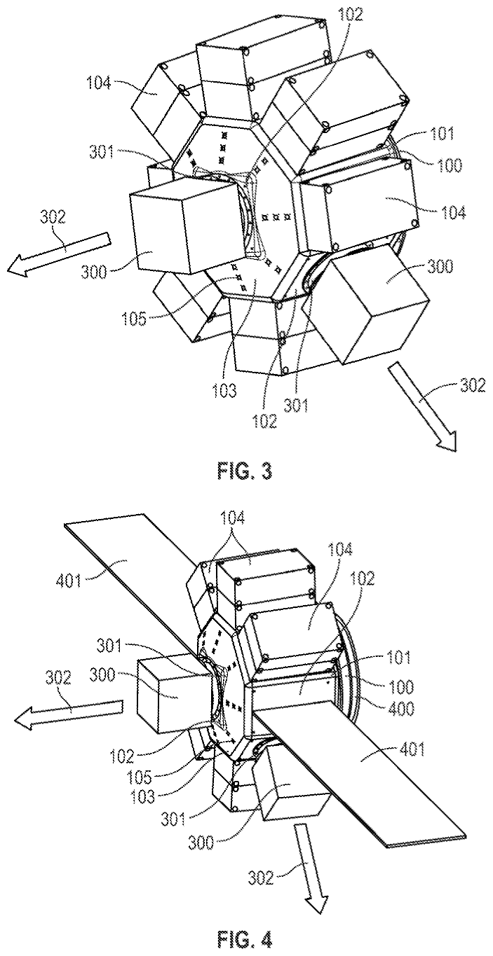

FIG. 3 illustrates the inventive device configured to deploy satellites 300 via satellite separation rings 301 well known in the art (e.g. Planetary Systems Mk II LightBand). Satellites 300 deploy in direction 302 when separation rings 301 release satellite 300. Electronic controller 200 supplies the needed separation signals for separation rings 301 to release satellites 300 via cables (not shown). A mixed manifest of CubeSat dispensers 104 is also illustrated.

FIG. 4 illustrates a further useful variant where a separation ring 400 is placed between the launch vehicle and launch vehicle adapter 100. This enables the entire assembly (i.e. launch vehicle adapter 100, structure 101, dispensers 104, separation rings 301 with satellites 300, etc.) to be released from the launch vehicle and form a free flying satellite. Additionally, the hollow space in structure 101 may be filled with avionics including attitude control systems (as are well known in the art), electrical power systems (as are well known in the art) and propulsion systems (as are well known in the art). Additionally, solar panels 401 (either fixed mount or deployable as illustrated) may be added to provide power to the free flying satellite. Thus, the inventive structure can readily provide a high strength to weight structure to a free flying satellite while performing its primary function as launch vehicle support structure for various dispensers 104 and 301.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A launch vehicle dispenser attach structure, comprising:
a launch vehicle adapter; and
a polygonal extruded cylinder comprising tapered side and an essentially closed end,
wherein said polygonal extruded cylinder connects to said launch vehicle adapter, and
wherein said tapered sides and said closed end of said polygonal extruded cylinder provide mounting interfaces for connecting satellite dispensers.

2. The launch vehicle dispenser attach structure of claim 1, wherein said launch vehicle adapter has a conical structure.

3. The launch vehicle dispenser attach structure of claim 1, wherein each of said mounting interfaces present a flat side.

4. The launch vehicle dispenser attach structure of claim 1, wherein said satellite dispensers have a rectangular structure.

5. The launch vehicle dispenser attach structure of claim 1, wherein said satellite dispensers have a cylindrical structure.

6. The launch vehicle dispenser attach structure of claim 1, wherein a mounting interface of said mounting interfaces comprises a separation ring.

7. The launch vehicle dispenser attach structure of claim 6, wherein said separation ring connects a satellite.

8. The launch vehicle dispenser attach structure of claim 6, wherein said separation ring releases said satellite.

9. The launch vehicle dispenser attach structure of claim 8, further comprises a controller, wherein controller provides a signal to said separation ring to release said satellite.

10. The launch vehicle dispenser attach structure of claim 6, wherein said separation ring locates between said launch vehicle adapter and a launch vehicle.

11. The launch vehicle dispenser attach structure of claim 10, wherein said separation ring permits said launch vehicle dispenser attach structure to be separated from said launch vehicle, and wherein separation of said launch vehicle dispenser attach structure from said launch vehicle transforms said launch vehicle dispenser attach structure into a free flying satellite.

12. The launch vehicle dispenser attach structure of claim 1, wherein said polygonal extruded cylinder comprises holes.

13. The launch vehicle dispenser attach structure of claim 12, wherein holes allow cables to pass through, wherein said cables provide control and power needed to operate said satellite dispensers.

14. The launch vehicle dispenser attach structure of claim 13, further comprises a controller, wherein controller provides a signal to power and deploy said satellite dispensers.

15. A method of providing a launch vehicle dispenser attach structure, said method comprising steps of:
providing a launch vehicle adapter; and
providing a polygonal extruded cylinder comprising tapered side and an essentially closed end;
connecting said polygonal extruded cylinder to said launch vehicle adapter; and
providing mounting interfaces with said tapered sides and said closed end of said polygonal extruded for connecting satellite dispensers.

16. The method of claim 15, further comprising providing a separation ring at said a mounting interface of said mounting interfaces.

17. The method of claim 16, further comprising:
providing said separation ring between said launch vehicle adapter and a launch vehicle;
controlling said separation ring to separate said launch vehicle dispenser attach structure from said launch vehicle; and
transforming said launch vehicle dispenser attach structure into a free flying satellite.

18. The method of claim 15, further comprising providing a controller for providing a signal to power and deploy said satellite dispensers.

19. The method of claim 16, further comprising connecting a satellite to separation ring.

20. The method of claim 16, further comprising providing a controller for providing a signal to said separation ring to release said satellite.
